(19) United States
(12) Patent Application Publication
(10) Pub. No.: US 2013/0114482 A1
(43) Pub. Date: May 9, 2013

(54) APPARATUS AND METHOD FOR CONTROLLING SESSION CONNECTION IN COMMUNICATION SYSTEM

(71) Applicants: Seong Keun Oh, Gyeonggi-do (KR); Jae Hyun Kim, Seoul (KR); Min Lee, Gyeonggi-do (KR); Hyun Jin Lee, Gyeongsangbuk-do (KR); Ji Su Kim, Gangwon-do (KR)

(72) Inventors: Seong Keun Oh, Gyeonggi-do (KR); Jae Hyun Kim, Seoul (KR); Min Lee, Gyeonggi-do (KR); Hyun Jin Lee, Gyeongsangbuk-do (KR); Ji Su Kim, Gangwon-do (KR)

(73) Assignee: AJOU UNIVERSITY INDUSTRY COOPERATION FOUNDATION, Gyeonggi-do (KR)

(21) Appl. No.: 13/810,479

(22) PCT Filed: Jul. 27, 2011
(86) PCT No.: PCT/KR11/05520

§ 371 Date: Jan. 16, 2013

(30) Foreign Application Priority Data
Jul. 27, 2010 (KR) 10-2010-0072627

(51) Int. Cl. H04W 80/00

(52) U.S. Cl. CPC H04W 80/00
USPC 370/310

(57) ABSTRACT

User equipment (UE) in a communication system controls session connection of at least one of a transport layer, a network layer, and a physical layer.

### TECHNICAL FIELD

The present invention relates to an apparatus and method for controlling session connection in a communication system.

### BACKGROUND ART

Research into next-generation communication systems is actively being performed to provide services having high-speed various quality of service (QoS) to user equipment (UE). Typical examples of the next-generation communication systems are an institute of electrical and electronics engineers (IEEE) 802.16 m communication system, a long term evolution (LTE) communication system, an IEEE 802.11n wireless local area network (WLAN) communication system, etc.

### DISCLOSURE OF INVENTION

### Technical Problem

Meanwhile, in a communication system, session control functions as a very critical factor in terms of quality of service (QoS), resource efficiency, transfer delay, overhead. However, in currently available communication systems, a user equipment (UE) controls only sessions of upper layers including a session layer, and sessions of lower layers including a network layer are separately controlled by network nodes including a router, a gateway, a NodeB, etc. included in a corresponding communication system.

Since sessions are separately controlled in each of layers included in each of network nodes included in a communication system, transfer delay and overhead occur due to information exchange between nodes and between layers for session control, and resource efficiency is also decreased thereby. Also, the transfer delay and overhead caused by information exchange between nodes and between layers may result in a decrease in QoS. Also, since only sessions of layers included in each of network nodes are controlled, user information is not used.

### Solution to Problem

One or more embodiments of the present invention provide an apparatus and method for controlling session control in a communication system.

The apparatus according to an embodiment of the present invention includes a session connection controller for controlling session connection of at least two sessions of a layer or each of at least two layers selected from the group consisting of a transport layer, a network layer, and a physical layer in a user equipment (UE) in a communication system.

The method according to an embodiment of the present invention includes controlling session connection of at least two sessions of a layer or each of at least two layers selected from the group consisting of a transport layer, a network layer, and a physical layer in a user equipment (UE) in a communication system.

### Advantageous Effects of Invention

A user equipment (UE) according to an embodiment of the present invention directly determines characteristics of a session of each of layers by using various application layer quality information, evaluation information including various transmission layer information including end-to-end transfer delay, end-to-end throughput, etc., and network supply information including a network load rate, use price, path information, according to service, and controls session connection, thereby guarantying supply of a user requirement service and improving network efficiency.

A UE according to an embodiment of the present invention determines session characteristics according to a layer, taking a lead to control handover between heterogeneous networks or between multiple cells in a network, thereby forming a dispersion control structure, and utilizes evaluation information and network supply information of the UE so that transfer delay and overhead caused by evaluation information acquirement and information exchange between heterogeneous networks which may occur in a conventional session management technology based on a network may be substantially reduced and a communication network resource may be efficiently used.

A UE according to an embodiment of the present invention directly controls session connection according to a layer, so that a multi-homing technology, in which a network connection service is supplied by connection with many networks through multiple transmission paths according to a layer, may be easily embodied. When the multi-homing technology is used, error prevention, service dispersion, etc., which are not achieved by only single connection, may be effectively provided and also, mobility is enhanced and selective change to politically and economically beneficial connection links is possible.

A UE according to an embodiment of the present invention enables supply of an inexpensive and high-speed wireless data service according to user s requirements and preference anywhere and anytime.

A UE according to an embodiment of the present invention enables network connection that is optimized in terms of a user so as to construct an always-online communication environment in which high quality multimedia service is stably supplied and necessary information is immediately obtained.

A UE according to an embodiment of the present invention reduces a burden of supplying mobility between heterogeneous networks out of network operators to remove obstacles to introduction of novel network and service, thereby enabling emergence of various networks and embodiment of a real mobile life.

A UE according to an embodiment of the present invention removes obstacles to network evolution and emergence of various access networks and services so as to induce various new service and access network emergence, thereby contributing to activation of service market even in a mobile communication-based ubiquitous communication environment in the future.

A UE according to an embodiment of the present invention may substantially contribute to an increase in a user equipment market share through maximization of added values.

A UE according to an embodiment of the present invention enhances communication network efficiency, and improves CAPEX/OPEX via optimized access network design, so as to reduce communication network costs and activate the equipment industry.

### BRIEF DESCRIPTION OF DRAWINGS

FIG. 1 is a schematic diagram illustrating sessions of layers in a communication system according to an embodiment of the present invention.

FIG. 2 is a diagram illustrating an example of an interior structure of a user equipment (UE) of a communication system according to an embodiment of the present invention.

FIG. 3 is a diagram illustrating another example of an interior structure of UE of a communication system according to an embodiment of the present invention.

FIG. 4 is a diagram illustrating another example of an interior structure of UE of a communication system according to an embodiment of the present invention.

FIG. 5 is a diagram illustrating another example of an interior structure of UE of a communication system according to an embodiment of the present invention.

FIG. 6 is a schematic diagram illustrating a session change process performed by UE in a communication system according to an embodiment of the present invention.

FIG. 7 is a schematic diagram illustrating a session connection process performed by UE in a communication system according to an embodiment of the present invention.

### BEST MODE FOR CARRYING OUT THE INVENTION

Hereinafter, one or more embodiments of the present invention will be described in detail with reference to the attached drawings. Also, if the detailed description on related known function and structure is considered to unnecessarily make the present invention unclear, it will not be presented herein.

The present invention provides an apparatus and method for controlling session connection in a communication system. In the present invention, an example of the communication system may be a multicell or heterogeneous network that includes at least one system selected from the group consisting of a long term evolution (LTE) communication system, an institute of electrical and electronics engineers (IEEE) 802.16m communication system, a WiBro communication system, and a wireless local area network (WLAN) communication system. Also, in addition to the LTE, IEEE 802.16m, and WLAN communication systems, a wireless communication system, such as Wireless Personal Area Network (WPAN), and a wired communication system, such as local area network (LANk) may also be included.

Prior to description of the present invention, the following terms will now be defined.

(1) User Requirement Service

This term refers to an act of efficiently supplying various media desired by a user, and the media includes audio media, video media, data media, etc. In this regard, the audio media includes audio, music, audio call, radio broadcasting, etc., the video media includes video broadcasting, video streaming, video conference, video call, etc., and the data media includes games, navigation, short message, WEB browsing, e-mails, file exchange, etc.

(2) Session

The term “session” refers to an information exchange flow between a transmission node and a receiving node, and a transmission path is a path for session. Herein, a session and a transmission path of each of layers will now be described below.

First, a session of a transport layer is a flow for exchanging a segment that constitutes a data stream of one user requirement service between end nods so as to provide requirement service, and a transmission path of the transport layer is a path for the session of the transport layer. Secondly, a session of a network layer is a connection flow between network layers each that constitute the session of the transport layer, and a flow for exchanging data packet that constitutes the segment between end nodes, and a transmission path of the network layer is a path for the session of the network layer.

Thirdly, a session of a physical layer is a connection flow between physical layers each that constitute a session of the network layer, and a signal exchange flow using a physical medium between a transmission node and a receiving node, and a transmission path of the physical layer is a path for a session of the physical layer.

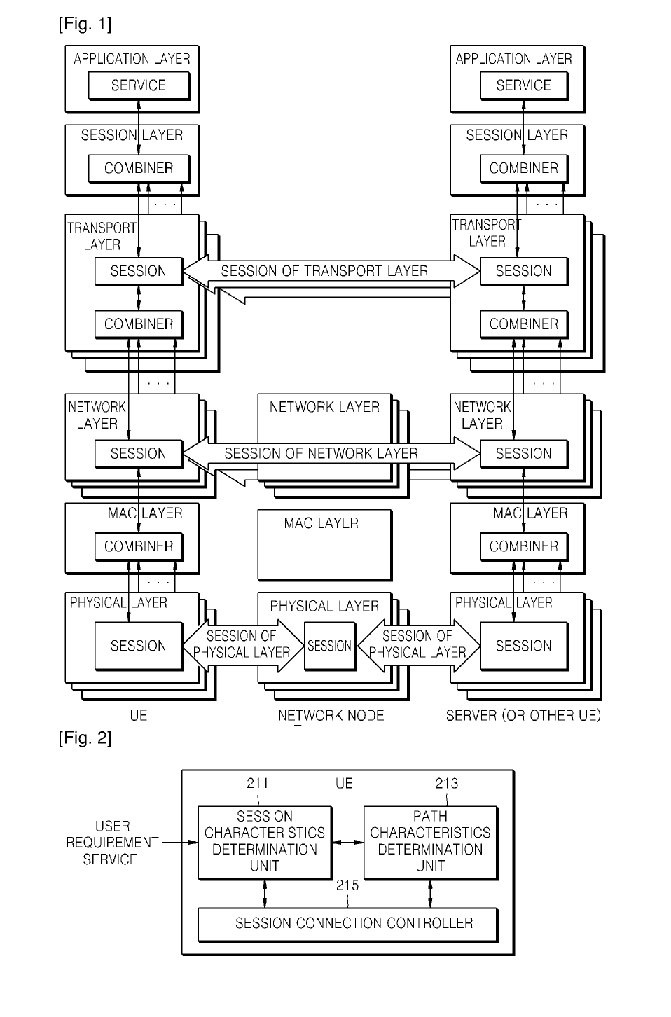

FIG. 1 is a schematic diagram illustrating sessions of layers in a communication system according to an embodiment of the present invention.

Referring to FIG. 1, a user equipment (UE) may generate at least one network node and at least one physical layer session. If the UE generates at least two physical layer sessions, a combiner of a medium access control (MAC) layer may perform a session connection operation for combining the at least two physical layer sessions into at least one medium connection control layer session, or dividing at least one medium connection control layer session into at least two physical layer sessions. In this regard, the UE may generate at least two network nodes and the at least two physical layer sessions. Also, if the UE generates at least two physical layer sessions, a combiner of a physical layer may perform a session connection operation for combining the at least two physical layer sessions into at least one physical layer session or dividing at least one physical layer session into at least two physical layer sessions.

Also, the UE may generate at least one server and at least one network layer session. In this regard, the server may be a UE that is different from the UE. If the UE generates at least two network layer sessions, a combiner of a transport layer may perform a session connection operation for combining the at least two network layer sessions into at least one transport layer session or dividing at least one transport layer session into at least two network layer sessions. In this regard, the UE may generate at least two servers and at least two network layer sessions. Also, when the UE generates at least two network layer sessions, the at least two network layer sessions may be established via either at least two different communication devices in an identical communication network, or at least two different communication networks. In this regard, examples of the communication device are NodeB, relay, a repeater, femtocell NodeB, etc., and examples of the communication network are LTE, IEEE 802.16m, WLAN, WiBro, WPAN, LAN, etc.

Also, the UE may generate at least one server and at least one transport layer session. If the UE generates at least two transport layer sessions, a combiner of a session layer may perform a session connection operation for combining the at least two transport layer sessions into at least one session layer session, or dividing at least one session layer session into at least two transport layer sessions. The UE may generate at least two servers and at least two transport layer sessions. Also, if the UE generates at least two transport layer sessions, the at least two transport layer sessions may be established via either at least two different communication devices in an identical communication network, or at least two different communication networks.

Also, a network node is a communication node between an UE and a server, and examples of the network node are relay, or NodeB, or a gateway, or a router, or a switch.

Also, sessions of layers of a LTE communication system illustrated in FIG. 1 are used for illustrative purpose only, and a combiner for performing session connection between layers may be embodied as separate modules in the respective layers, or may be integrally embodied as one module. If the combiner for performing session connection between layers is unified as one module, the combiner may separately or wholly perform session connection of the respective layers.

In this regard, characteristics of the respective layer sessions will now be described in detail.

First, characteristics of a session of a transport layer will now be described in detail.

Characteristics of a session of a transport layer include a session size of the transport layer and a session QoS parameter of the transport layer. In this regard, an example of the session size of the transport layer is a segment throughput, and examples of the session QoS parameter of the transport layer are a segment transfer delay, a retransmission count, a round trip time (RTT), a segment throughput, a segment loss, etc. In this regard, the segment transfer delay refers to a time period between when a corresponding segment is received and when a next segment is received. The retransmission count refers to a segment retransmission count per unit hour. The RTT refers to a time period between when a segment is transmitted and when a response corresponding to the segment is received. The segment throughput refers to a segment transmission amount per unit hour. The segment loss refers to a segment loss probability occurring during segment transmission.

For example, the session QoS parameter of the transport layer includes at least two parameters selected from the group consisting of the segment transfer delay, the retransmission count, RTT, the segment throughput, and the segment loss.

Secondly, characteristics of a session of a network layer will now be described in detail.

Characteristics of a session of a network layer include a session size of the network layer and a session QoS parameter of the network layer. In this regard, an example of the session size of the network layer is a segment throughput, and examples of the session QoS parameter of the network layer are jitter, packet transfer delay, packet loss, packet throughput, use price, etc. The jitter refers to a dispersion of packet arrival time periods, and a degree of packet arrival time change. The packet transfer delay refers to a time period between when a corresponding packet is received and when a next packet is received. The packet loss refers to a segment loss probability occurring during packet transmission. The packet throughput refers to a packet transmission amount per unit time. The use price refers to a cost for network connection and utilization performed by UE per unit time (or unit packet).

For example, the session QoS parameter of the network layer includes at least two parameters selected from the group consisting of the jitter, packet transfer delay, packet loss, packet throughput, and use price.

Thirdly, characteristics of a session of a physical layer will now be described in detail.

Characteristics of a session of a physical layer include a session size of the physical layer and a session QoS parameter of the physical layer. In this regard, an example of the session size of the physical layer is a channel capacity, and examples of the session QoS parameter of the physical layer are a signal to noise ratio (SNR), a signal to interference and noise ratio (SINR), a received signal strength indicator (RSSI), channel capacity, a suppliable data rate, a suppliable data rate dispersion, error rate, outage rate, signal transfer delay, etc. In this regard, the RSSI refers to a received signal strength measured in a receiving node, the SNR refers to a ratio of signal power to noise power, the SINR refers to a signal power ratio with respect interference and noise power, and the channel capacity refers to an maximum amount of information that is transmissible through a channel without error. Also, the suppliable data rate refers to an actually transmissible data rate that is determined in consideration of channel characteristics elements, and may be an instantaneous data rate or an mean data rate, and may include a total data rate, a data rate according to a user, a data rate according to a stream, etc. The suppliable data rate dispersion refers to a degree of suppliable data rate change according to channel characteristics, and the error rate refers to an error probability occurring during signal transmission and may include a bit error rate (BER), block error rate (BLER), a frame error rate (FER), a packet error rate (PER), etc. The outrage rate is a communication outrage probability occurring when a channel quality is equal to or lower than a communication outrage reference that has set in advance, and the communication outrage reference may include RSSI, SNR, SINR, error rate, channel capacity, suppliable data rate, etc. For example, if the communication outrage reference is 0 [dB] SNR, the outrage rate of UE is determined according to a probability that SNR of UE experiences a channel equal to or lower than 0 [dB]. The signal transfer delay refers to a time period between when a corresponding signal is received and when a next signal is received.

For example, the session QoS parameter of the physical layer includes at least two parameters selected from the group consisting of SNR, SINR, RSSI, channel capacity, suppliable data rate, suppliable data rate dispersion, error rate, outrage rate, and signal transfer delay.

Also, at least two selected from the characteristics of the sessions of the layers may be combined to define one parameter, and the defined parameter may be used as a session connection control parameter. For example, SINR, which is a characteristic of the session of the physical layer, is combined with transfer delay and packet loss, which are characteristics of the session of the network layer so as to define one parameter, that is, a required bandwidth (BW). In this regard, the required BW is a resource amount of a transmission path required for supplying a user requirement service, and may be obtained, as shown in Equation 1 below, by dividing an effective data rate by frequency efficiency:

$$\begin{matrix}MathFigure 1 & \\ Required {BW}_{1} [ Hz ] = \frac{Effective data rate , [ b / s ]}{Spectral efficiency , [ b / s / Hz ]} & [ Math .1 ]\end{matrix}$$

The effective data rate is calculated in consideration of QoS requirements including a peak data rate, a mean data rate, delay bound, packet loss ratio, a maximum burst size, etc., by using Equation 2 below:

MathFigure 2

ERᵢ=g×sᵢ×(1−L) [Math.2]

In Equation 2, ERᵢ is the effective data rate, L is a required packet loss rate, and g is a data rate that is required to satisfy QoS requirements including delay bound (D), maximum burst size(s), etc. and may have a value between a peak data rate (Rₚₑₐₖ) and a mean data rate (Rₘₑₐₙ) according to a service. For example, a requirement data rate (g) for a service, such as video streaming or game, in which delay bound, data rate, and burst size all substantially affect QoS may be obtained by using Equation 3 below.

$$\begin{matrix}MathFigure 3 & \\ g = \frac{σ {R}_{peak}}{σ + {DR}_{peak}} & [ Math .3 ]\end{matrix}$$

As another example, a requirement data rate (g) for a service, such as WEB browsing, E-mail, or file exchange, that is relatively not sensitive to delay may be defined as a mean data rate (Rₘₑₐₙ) as shown in Equation 4 below.

MathFigure 4

g=Rₘₑₐₙ [Math.4]

Also, sᵢ in Equation 2 is a transmission count that is needed to transmit one packet successfully, and varies according to a channel situation. In this regard, if a packet error rate of path i is p_{e,i} and a maximum transmission count is 1, SINR according a path and corresponding BER and PER are shown as Equation 5:

$$\begin{matrix}MathFigure 5 & \\ {s}_{i} = \frac{1 - {p}_{e , i}^{l + 1}}{1 - {p}_{e , i}} & [ Math .5 ]\end{matrix}$$

Also, the spectral efficiency in Equation 1 is a value that is determined according to a modulation and coding scheme (MCS) level in consideration of path characteristics of, for example, SINR. For example, spectral efficiency values are shown in Table 1 below.

TABLE 1

| | Coding | Receiver | Spectral |
|---|---|---|---|
| Modulation | rate | SINR (dB) | Efficiency (b/s/Hz) |
| QPSK | ⅓ | −1.3 | 0.6222 |
| | ½ | 1.1 | 0.9333 |
| | ⅔ | 3.3 | 1.2444 |
| | ⅘ | 4.5 | 1.4933 |
| 16-QAM | ⅓ | 5.2 | 1.2444 |
| | ½ | 6.4 | 1.8667 |
| | ⅔ | 7.4 | 2.4889 |
| | ⅘ | 10.6 | 2.9867 |
| | ⅓ | 10.9 | 1.8667 |
| | ½ | 11.5 | 2.8000 |
| 64-QAM | ⅔ | 14.3 | 3.7333 |
| | ⅘ | 16.8 | 4.4800 |

Then, a user experience quality will now be described in detail.

A user experience quality parameter may vary according to a service, which will now be described in detail.

First, a user experience quality parameter for audio service includes mean opinion score (MOS), a un-response rate to call, R-value, etc. The MOS refers to a QoS evaluated in consideration of human recognition characteristics, the un-response rate to call refers to a probability that an outrage state of audio call occurs, and the R-value refers to a quality index representing a quality that is recognizable by using network environment information within a measurement range.

Secondly, a user experience quality parameter for a video streaming service includes initial buffering time, jerkiness, audio and video synchronization, etc. The initial buffering time refers to a time period between from when a user requires a video streaming service and when the user receives an initial service, following buffering of predetermined data, and the jerkiness refers to a measurement value about continuation of video stopped image or a degree that motions are viewed as being not naturally continuous.

Thirdly, a user experience quality parameter for a WEB browsing service includes a page response time, etc. The page response time refers to a time period between when a user requires a WEB page and when the user receives a corresponding page.

Fourthly, a user experience quality parameter for a file exchange service includes a data rate, a download time, etc. The data rate refers to a data transmission rate per unit time, and the download time refers to a total time for receiving a required file.

Then, an interior structure of UE of a communication system according to an embodiment of the present invention will now be described in detail with reference to FIGS. 2 to 5.

FIG. 2 is a diagram illustrating an example of an interior structure of UE of a communication system according to an embodiment of the present invention.

Referring to FIG. 2, the UE includes a session characteristics determination unit 211, a path characteristics determination unit 213, and a session connection controller 215. The session characteristics determination unit 211 determines characteristics of at least one session selected from the group consisting of a transport layer, a network layer, and a physical layer. That is, to supply a user requirement service, the session characteristics determination unit 211 determines at least one session selected from the group consisting of a transport layer, a network layer, and a physical layer. The path characteristics determination unit 213 elects a transmission path for connection of at least one session selected from the group consisting of a transport layer, a network layer, and a physical layer, and determines characteristics of the elected transmission path. That is, the path characteristics determination unit 213 elects a transmission path for connection of a session of which characteristics are determined by the session characteristics determination unit 211, and determines characteristics of the elected transmission path. In this regard, the characteristics of the transmission path may include a session size according to a path, a transmission characteristic according to a path, etc.

The session connection controller 215 controls connection of at least one session selected from the group consisting of a transport layer, a network layer, and a physical layer. That is, the session connection controller 215 controls at least one operation selected from the group consisting of session establishment, session close, session change, and session connection for connection of a session of which characteristics are determined by the session characteristics determination unit 211 by using a transmission path that is elected by the path characteristics determination unit 213. Detailed descriptions of the session establishment, the session close, the session change, and the session connection will be described in detail later.

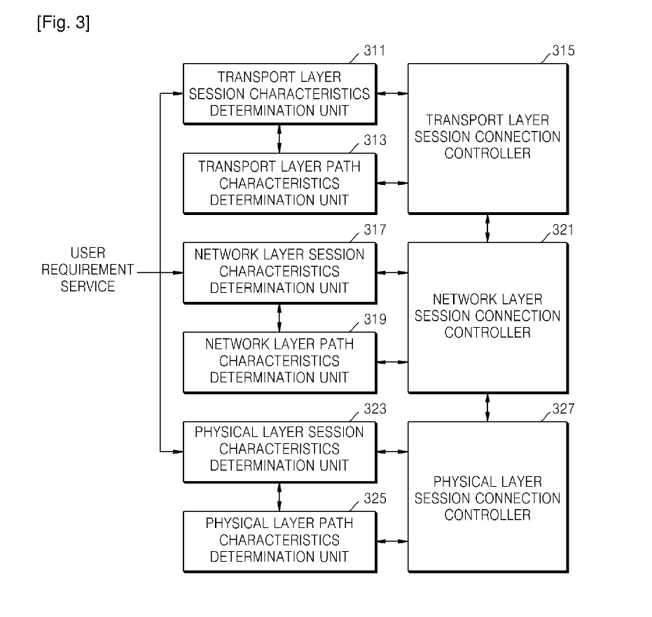

As described above, in the UE interior structure illustrated in FIG. 2, all the layers commonly share one session characteristics determination unit, one path characteristics determination unit, and one session connection controller. However, the UE interior structure illustrated in FIG. 2, each of the layers may include a session characteristics determination unit, a path characteristics determination unit, and a session connection controller, and this embodiment will now be described in detail with reference to FIG. 3.

FIG. 3 is a diagram illustrating another example of the UE interior structure of a communication system according to an embodiment of the present invention.

Referring to FIG. 3, the UE includes a transport layer session characteristics determination unit 311, a transport layer path characteristics determination unit 313, transport layer session connection controller 315, a network layer session characteristics determination unit 317, a network layer path characteristics determination unit 319, a network layer session connection controller 321, a physical layer session characteristics determination unit 323, a physical layer path characteristics determination unit 325, and a physical layer session connection controller 327. The transport layer session characteristics determination unit 311 determines characteristics of a session of a transport layer to supply a user requirement service.

The transport layer path characteristics determination unit 313 elects a transmission path for a session of a transport layer, and determines characteristics of the elected transmission path. That is, the transport layer path characteristics determination unit 313 elects a transmission path for connection of a session of which characteristics are determined by the transport layer session characteristics determination unit 311, and determines characteristics of the elected transmission path.

The transport layer session connection controller 315 controls connection of a session of a transport layer. That is, the transport layer session connection controller 315 controls at least one operation selected from the group consisting of session establishment, session close, session change, session connection for connection of a session of which characteristics are determined by the transport layer session characteristics determination unit 311 by using a transmission path that is elected by the transport layer path characteristics determination unit 313.

The network layer session characteristics determination unit 317 determines characteristics of a network layer to supply a user requirement service.

The network layer path characteristics determination unit 319 elects a transmission path for a session of a network layer, and determines characteristics of the elected transmission path. That is, the network layer path characteristics determination unit 319 elects a transmission path for a session of which characteristics are determined by the network layer session characteristics determination unit 317, and determines characteristics of the elected transmission path.

The network layer session connection controller 321 controls connection of a session of a network layer. That is, the network layer session connection controller 321 controls at least one operation selected from the group consisting of session establishment, session close, session change, session connection for connection of a session of which characteristics are determined by the network layer session characteristics determination unit 317 by using a transmission path that is elected by the network layer path characteristics determination unit 319.

The physical layer session characteristics determination unit 323 determines characteristics of a session of a physical layer to supply a user requirement service.

The physical layer path characteristics determination unit 325 elects a transmission path for a session of a physical layer, and determines characteristics of the elected transmission path. That is, the physical layer path characteristics determination unit 325 elects a transmission path for a session of which characteristics are determined by the physical layer session characteristics determination unit 323, and determines characteristics of the elected transmission path.

The physical layer session connection controller 327 controls connection of a session of a physical layer. That is, the physical layer session connection controller 327 controls at least one operation selected from the group consisting of session establishment, session close, session change, and session connection for connection of a session of which characteristics are determined by the physical layer session characteristics determination unit 323 by using a transmission path that is elected by the physical layer path characteristics determination unit 325.

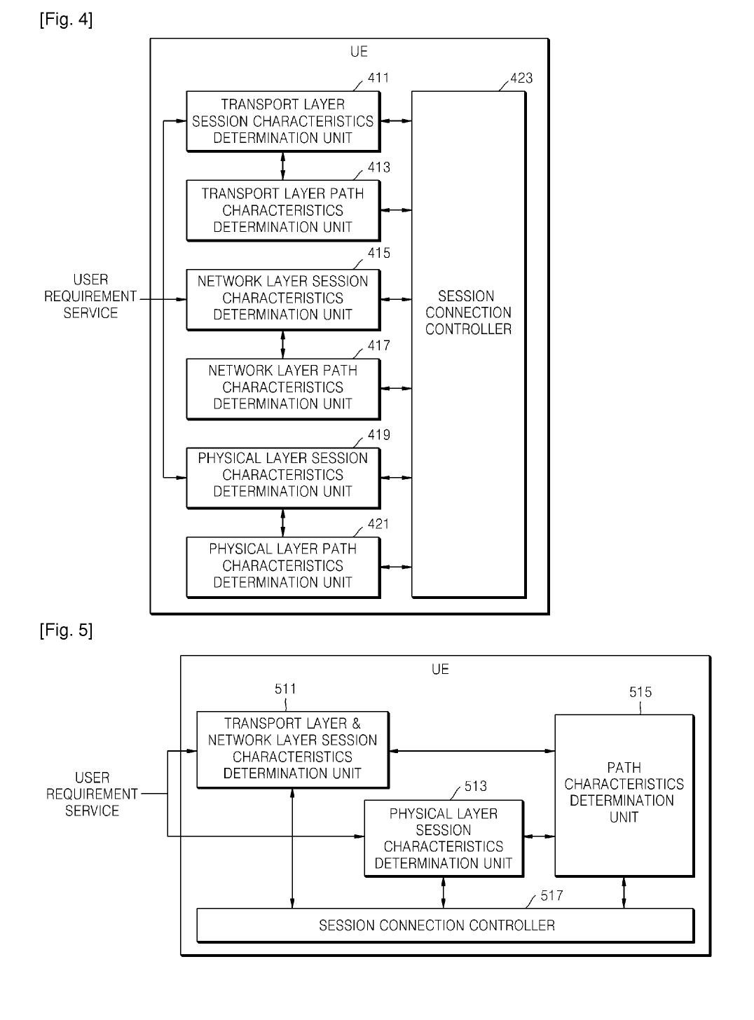

As described above, in the UE interior structure illustrated in FIG. 3, each of the layers includes a session characteristics determination unit, a path characteristics determination unit, and a session connection controller. However, unlike the UE interior structure illustrated in FIG. 3, each of the layers may include a session characteristics determination unit and a path characteristics determination unit, and all the layers may commonly share one session connection controller. This embodiment will now be described with reference to FIG. 4.

FIG. 4 is a diagram illustrating another example of the UE interior structure of a communication system according to an embodiment of the present invention.

Referring to FIG. 4, the UE includes a transport layer session characteristics determination unit 411, a transport layer path characteristics determination unit 413, a network layer session characteristics determination unit 415, a network layer path characteristics determination unit 417, a physical layer session characteristics determination unit 419, a physical layer path characteristics determination unit 421, and a session connection controller 423. The transport layer session characteristics determination unit 411 determines characteristics of a session of a transport layer to supply a user requirement service.

The transport layer path characteristics determination unit 413 elects a transmission path for a session of a transport layer, and determines characteristics of the elected transmission path. That is, the transport layer path characteristics determination unit 413 elects a transmission path for connection of a session of which characteristics are determined by the transport layer session characteristics determination unit 411, and determines characteristics of the elected transmission path. The network layer session characteristics determination unit 415 determines characteristics of a network layer to supply a user requirement service.

The network layer path characteristics determination unit 417 elects a transmission path for a session of a network layer, and determines characteristics of the elected transmission path. That is, the network layer path characteristics determination unit 417 elects a transmission path for a session of which characteristics are determined by the network layer session characteristics determination unit 415, and determines characteristics of the elected transmission path.

The physical layer session characteristics determination unit 419 determines characteristics of a session of a physical layer to supply a user requirement service.

The physical layer path characteristics determination unit 421 elects a transmission path for a session of a physical layer, and determines characteristics of the elected transmission path. That is, the physical layer path characteristics determination unit 421 elects a transmission path for a session of which characteristics are determined by the physical layer session characteristics determination unit 419, and determines characteristics of the elected transmission path. The session connection controller 423 controls connection of at least one session selected from the group consisting of a transport layer, a network layer, and a physical layer. That is, the session connection controller 423 controls connection of at least one session selected from the group consisting of a transport layer, a network layer, and a physical layer for connection of a session of which characteristics are determined by the transport layer session characteristics determination unit 411 by using a transmission path that is elected by the transport layer path characteristics determination unit 413. Also, the session connection controller 423 controls connection of at least one session selected from the group consisting of a transport layer, a network layer, and a physical layer for connection of a session of which characteristics are determined by the network layer session characteristics determination unit 415 by using a transmission path that is elected by the network layer path characteristics determination unit 417. Also, the session connection controller 423 controls connection of at least one session selected from the group consisting of a transport layer, a network layer, and a physical layer for connection of a session of which characteristics are determined by the physical layer session characteristics determination unit 419 by using a transmission path that is elected by the physical layer path characteristics determination unit 421.

As described above, in the UE interior structure illustrated in FIG. 4, each of the layers includes a session characteristics determination unit and a path characteristics determination unit, and all the layers commonly share one session connection controller session connection controller. However, unlike the UE interior structure illustrated in FIG. 4, at least two layers selected from the group consisting of a transport layer, a network layer, and a physical layer may commonly share at least one selected from the group consisting of a session characteristics determination unit, a path characteristics determination unit, and a session connection controller, and at least one layer selected from the group consisting of a transport layer, a network layer, and a physical layer may include a session characteristics determination unit, a path characteristics determination unit, and a session connection controller. This embodiment will now be described with reference to FIG. 5.

FIG. 5 is a diagram illustrating another example of the UE interior structure of a communication system according to an embodiment of the present invention.

Referring to FIG. 5, the UE includes a transport layer & network layer session characteristics determination unit 511, a physical layer session characteristics determination unit 513, a path characteristics determination unit 515, and a session connection controller 517. As illustrated in FIG. 5, a transport layer and a network layer commonly share a session characteristics determination unit, that is, a transport layer & network layer session characteristics determination unit 511, and a physical layer has an independent session characteristics determination unit, that is, a physical layer session characteristics determination unit 513. Also, all the layers commonly share a path characteristics determination unit 515 and a session connection controller 517.

Also, the UE may have interior structures other than the structures illustrated in FIGS. 2 to 5, and these UE interior structures will now be described in detail.

According to an embodiment, each of the layers may include a session characteristics determination unit, all the layers may commonly share one path characteristics determination unit, and each of the layers may include a session connection controller. That is, the UE may include a transport layer session characteristics determination unit, a network layer session characteristics determination unit, a physical layer session characteristics determination unit, a path characteristics determination unit, a transport layer session connection controller, a network layer session connection controller, and a physical layer session connection controller.

According to another embodiment, each of the layers may include a session characteristics determination unit, and all the layers may commonly share one path characteristics determination unit and one session connection controller. That is, the UE may include a transport layer session characteristics determination unit, a network layer session characteristics determination unit, a physical layer session characteristics determination unit, a path characteristics determination unit, and a session connection controller.

According to another embodiment, all the layers may commonly share one session characteristics determination unit, and each of the layers may include a path characteristics determination unit and a session connection controller. That is, the UE may include a session characteristics determination unit, a transport layer path characteristics determination unit, a network layer path characteristics determination unit, a physical layer path characteristics determination unit, a transport layer session connection controller, a network layer session connection controller, and a physical layer session connection controller.

According to another embodiment, all the layers may commonly share one session characteristics determination unit and one session connection controller, and each of the layers may include a path characteristics determination unit. That is, the UE may include a session characteristics determination unit, a transport layer path characteristics determination unit, a network layer path characteristics determination unit, a physical layer path characteristics determination unit, and a session connection controller.

According to another embodiment, all the layers may commonly share one session characteristics determination unit and one path characteristics determination unit, and each of the layers includes a session connection controller. That is, the UE may include a session characteristics determination unit, a path characteristics determination unit, a transport layer session connection controller, a network layer session connection controller, and a physical layer session connection controller.

Hereinafter, operations of a session characteristics determination unit, a path characteristics determination unit, and a session connection controller will be described in detail.

First, an operation of a session characteristics determination unit will now be described in detail.

The session characteristics determination unit determines characteristics of a session of a layer to supply a service, and the characteristics of a session of a layer include a session size, session connection mode (multiplexing, diversity, or a hybrid including multiplexing and diversity), session flexibility (service and traffic, network load, or flexibility corresponding to channel state), QoE parameter, etc. For example, if the session characteristics determination unit, when the flexibility corresponding to channel state is set to a high level, gives a current channel state a margin and determines characteristics of a session relatively generously. Accordingly, even when the channel state is relatively poor, the current session state may be allowed to be maintained as long as the channel state change is within the predetermined range.

The session characteristics determination unit utilizes at least one selected from the group consisting of service characteristics information, communication quality information, network information, channel characteristics information, when the session characteristics determination unit determines characteristics of a session of a layer to supply a user requirement service. In addition, at least two of these may be used in combination. In this regard, the service characteristics information includes user preference, QoE requirement parameter according to a session, service price, etc. Also, the communication quality information may be directly measured and collected by UE, and includes communication quality information of an application layer, communication quality information of a session layer, communication quality information of a transport layer, communication quality information of a network layer, communication quality information of a MAC layer, and communication quality information of a physical layer.

In this regard, the communication quality information of the application layer includes availability, reconstruction quality, time constraint, service price, MOS, data rate, jitter, transfer delay, a peak signal-to-noise ratio (PSNR), etc.; the communication quality information of the session layer includes a session state (normal or abnormal session connection), etc.; the communication quality information of the transport layer includes an end-to-end retransmission rate, end-to-end transfer delay, end-to-end segment loss, end-to-end throughput, segment delay change, etc.; the communication quality information of the network layer includes QoS information, routing information, packet loss, packet transfer delay, packet throughput, etc.; the communication quality information of the MAC layer includes a link retransmission rate, FER, etc.; and the communication quality information of the physical layer includes BER, signal strength, etc.

Also, the network information refers to information supplied by networks with which the UE are to have connection, and includes neighbor list (NL) information, a network load rate, price policy, etc. The channel characteristics information refers to transmission parameter information for network connection of UE, and includes modulation method information, coding method information, transmit and receive method information, multiple antenna method information, etc.

Secondly, an operation of a path characteristics determination unit will now be described in detail.

The path characteristics determination unit elects a transmission path of a session of at least one layer determined by the session characteristics determination unit, and determines characteristics of the elected transmission path. The path characteristics determination unit may elect at least one transmission path from among all transmission paths available between UE and another UE for each layer to supply a user requirement service.

The path characteristics determined by the path characteristics determination unit include a session size according to a path, transmission characteristics according to a path, etc. In this regard, when the path characteristics determination unit determines a session size according to a path, when at least one layer elects at least two paths, to supply a user requirement service, the at least one layer elects determines the session size of each of the paths required to provide the user requirement service. Also, when the path characteristics determination unit determines transmission characteristics according to a path, when at least one layer elects at least two paths, to supply a user requirement service, the at least one layer determines transmission characteristics of each of the path required to provide the user requirement service. In this regard, the transmission characteristics include a transmission order, transmission time, etc.

Thirdly, an operation of a session connection controller will now be described in detail.

The session connection controller controls at least one selected from the group consisting of session establishment, session close, session change, and session connection for connection of a session of at least one layer of which characteristics are determined by the session characteristics determination unit by using at least one path determined by the path characteristics determination unit. Hereinafter, each of the session establishment, the session close, the session change, and the session connection will be described in detail.

(1) Session Establishment

The session establishment refers to a process in which UE establishes a session of at least one layer by using at least one path, when data for transmission is generated or when a new user requirement service is required. In this regard, the UE may establish a session of at least one layer by using at least two transmission paths in consideration of characteristics of a session to supply a user requirement service. Also, the session establishment requires a resource allocation process.

(2) Session Close

The session close refers to a process in which UE closes a session of at least one layer that is currently established. In this regard, the UE may close the whole or a portion of a transmission path that is established for a session of a corresponding layer. Also, the session close requires a resource return process.

(3) Session Change

The session change refers to a process in which UE changes the whole or a portion of transmission paths of at least one layer currently in use to supply a user requirement service, or at least one of session sizes and session characteristics of the whole or a portion of transmission paths of at least one layer currently in use, when there is a need to change a transmission path for connection of a session of at least one layer, for example, when a session of at least one layer currently used by UE does not satisfy a user requirement QoS, or when the session exceeds a user requirement QoS, or when a user requirement QoS is changed.

For example, when a user requirement QoS is changed, the session connection controller may increase or decrease the transmission path size of at least one selected from the group consisting of a transport layer, a network layer, and a physical layer currently in use. Alternatively, when at least one transmission path currently in use is insufficient, a new transmission path of at least one layer may be additionally used, or when transmission paths of at least one layer currently in use are excessive, transmission paths of at least one layer may be closed. In this regard, when the transmission path is changed, the session connection controller may change a transmission path within the same communication network, or may use a transmission path of different communication networks. In this case, the session connection controller may use transmission paths of at least two different communication networks simultaneously.

Also, the session change requires a resource allocation process and a resource return process, and even when the current QoS is changed, if a user requirement service is suppliable with the current session, the current session may be maintained.

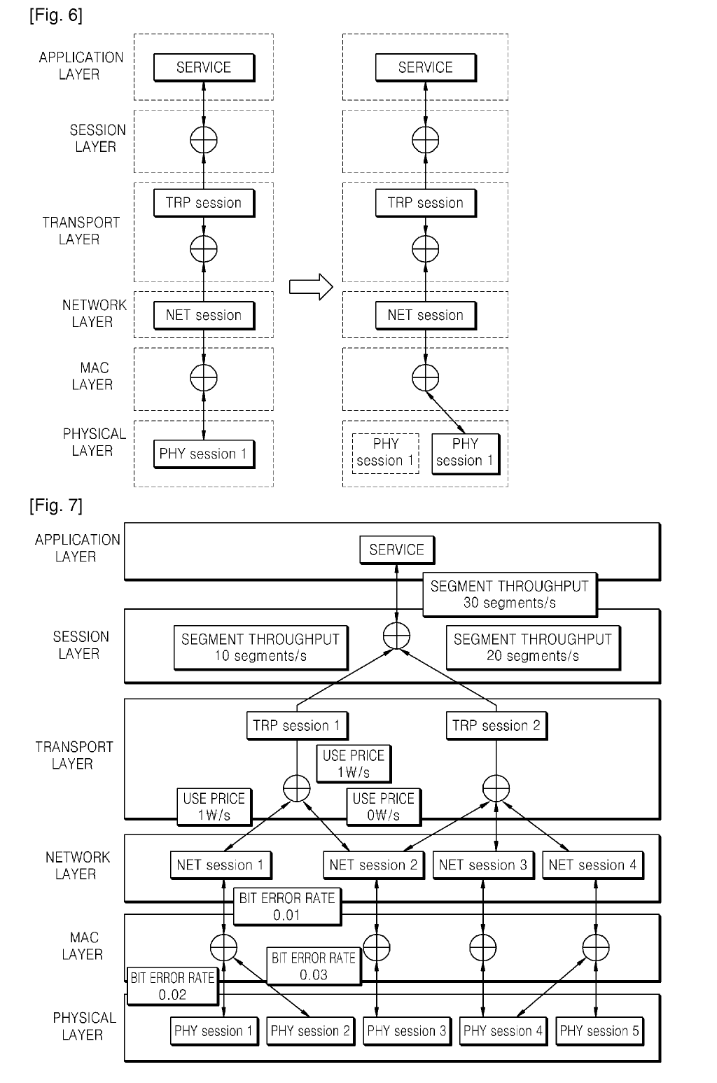

Hereinafter, with reference to FIG. 6, session change performed by UE in a communication system according to an embodiment of the present invention will be described in detail.

FIG. 6 is a schematic diagram illustrating a session change process performed by UE in a communication system according to an embodiment of the present invention.

The session change process illustrated in FIG. 6 is a process for changing a session of a physical layer, and in FIG. 6, the term “TRP session” refers to a transport layer session, the term “NET session” refers to a network layer session, and the term “PHY session” refers to a physical layer session.

Referring to FIG. 6, when during a user requirement service is supplied using a physical layer session 1, it is difficult to supply the user requirement service using the physical layer session 1 due to a particular cause, the US searches for a new physical layer session that enables supply of a user requirement service. In this regard, an example of the particular cause may be a decrease in SNR or an increase in signal transfer delay. That is, when during a user requirement service is supplied using a physical layer session 1, it is difficult to supply the user requirement service using the physical layer session 1 due to a decrease in SNR or an increase in signal transfer delay, the UE searches for a new physical layer session that enables supply of a user requirement service. Also, if the searched physical layer session is a physical layer session 2, the UE performs session change from the physical layer session 1 to the physical layer session 2. Also, although not illustrated in the drawings herein, the UE may change, in addition to a session of a physical layer as described above, a session of a transport layer and a session of a network layer. The latter cases will now be described in detail.

Regarding network layer session change, when during a user requirement service is supplied using a network layer session 1, it is difficult to supply the user requirement service using the network layer session 1 due to a particular cause, the US searches for a new network layer session that enables supply of a user requirement service. In this regard, an example of the particular cause may be an increase in a packet error rate (PER), a high use price, or an increase in packet transfer delay. That is, when during a user requirement service is supplied using a network layer session 1, it is difficult to supply the user requirement service using the network layer session 1 due to an increase in a PER, a high use price, or an increase in packet transfer delay, the US searches for a new network layer session that enables supply of a user requirement service. Also, if the searched network layer session is a network layer session 2, the UE performs session change from the network layer session 1 to the network layer session 2.

Regarding transport layer session change, when during a user requirement service is supplied using a transport layer session 1, it is difficult to supply the user requirement service using the transport layer session 1 due to a particular cause, the US searches for a new transport layer session that enables supply of a user requirement service. In this regard, an example of the particular cause may be an increase in a round trip time (RTT), an increase in retransmission count, or a decrease in segment throughput. That is, when during a user requirement service is supplied using a transport layer session 1, it is difficult to supply the user requirement service using the transport layer session 1 due to an increase in a PER, a high use price, or an increase in packet transfer delay, the US searches for a new transport layer session that enables supply of a user requirement service. Also, if the searched transport layer session is a transport layer session 2, the UE performs session change from the transport layer session 1 to the transport layer session 2.

Hereinafter, a session connection process performed by UE in a communication system according to an embodiment of the present invention will be described in detail.

First, session connection is a process in which UE, to receive a user requirement service, establishes at least two sessions of at least one layer by using at least two transmission paths, and divides and transmits information about the user requirement service at least one layer by using at least two transmission paths, or matches information transmitted to at least one layer through at least two transmission paths.

That is, session connection is a process for dividing at least one session layer session into at least two transport layer sessions, dividing at least one transport layer session into at least two network layer sessions, dividing at least one MAC layer session into at least two physical layer sessions, combining at least two transport layer sessions into a session of at least one session layer, combining at least two network layer sessions into at least one transport layer session, or combining at least two physical layer sessions into at least one MAC layer session.

Also, when in a session establishment process, at least two sessions are established in at least one layer for one user requirement service, a session connection process for combining the at least two sessions is needed. In this regard, when identical information is received by using at least two sessions, the session connection may be performed in a diversity connection manner in which among identical information received using the at least two sessions, only one is elected.

However, when different information is received by using at least two sessions, the session connection may be performed in a multiplexing connection manner in which information received by using the at least two sessions is aligned according to a sequence and then combined into one.

Unlike these cases, when at least two sessions simultaneously receive identical information and different information, the UE performs diversity connection with respect to the identical information and the UE performs multiplexing connection with respect to different information. That is, when at least two sessions are used, the UE performs diversity connection with respect to a portion of at least one session of the at least two sessions and a corresponding residual session by receiving identical information, and the UE performs multiplexing connection with respect to the remaining portion and a corresponding residual session by receiving different information. For example, when a user requirement service is supplied using a transport layer session 1 and a transport layer session 2, the UE performs diversity combination session connection by receiving identical segments through a first sub-session of the transport layer session 1 that has a session size that is ⅓ of the transport layer session 1 and a first sub-session of the transport layer session 2 that has a session size that is ½ of the transport layer session 2. Simultaneously, by receiving different segments through a second sub-session of the transport layer session 1 that has a session size of ⅔ of the transport layer session 1, and other different segments through a second sub-session of the transport layer session 2 that has a session size of ½ of the transport layer session 2, a segment obtained by diversity combination session connection of segments received through the first sub-session of the transport layer session 1 and the first sub-session of the transport layer session 2 is combined with segments received through the second sub-session of the transport layer session 1 and a segment received through the second sub-session of the transport layer session 2 by multiplexing combination session connection.

According to another embodiment, when a WEB browsing service is supplied using a network layer session 1 and a network layer session 2, the UE performs diversity combination session connection by receiving identical packets that constitute image information of the WEB browsing service through a first sub-session of the transport layer session 1 that has a session size that is ½ of the transport layer session 1 and the transport layer session 2. Simultaneously, by receiving packets that constitute text information of the WEB browsing service through a second sub-session of the transport layer session 1 that has a session size of the residual ½ of the transport layer session 1, a packet obtained by diversity combination session connection of the packets received through the first sub-session of the network layer session 1 and the network layer session 2 is combined with the packet received through the second sub-session of the network layer session 1 by multiplexing combination session connection.

In this way, data received through a session of a physical layer, in addition to a session of a transport layer and a session of a network layer, may be combined by session connection. Also, when identical information is transmitted using at least two sessions, a session connection process is performed in a diversity division manner in which identical information is divided and transmitted using the at least two sessions. Alternatively, when different information is transmitted using at least two sessions, a session connection process is performed in a multiplexing division manner in which different information is divided and transmitted using the at least two sessions.

Alternatively, identical information and different information are each divided for at least two sessions, and the UE performs diversity transmission with respect to the identical information and the UE performs multiplexing transmission with respect to different information. That is, when at least two sessions are used, the UE performs diversity division session connection with respect to a portion of at least one session of the at least two sessions and a corresponding residual session perform by transmitting identical information therethrough, and the UE performs multiplexing division session connection with respect to the remaining portion and a corresponding residual session perform by transmitting different information. For example, when a user requirement service is supplied using a physical layer session 1 and a physical layer session 2, the UE performs a diversity division session connection with a first sub-session of the physical layer session 1 that has a session size that is ½ of the physical layer session 1 and the physical layer session 2 respect to by transmitting identical signals through the first sub-session of the physical layer session 1 and the physical layer session 2. Simultaneously, by transmitting other signals through a second sub-session of the physical layer session 1 that has a session size of the residual ½ of the physical layer session 1, a signal obtained by the diversity division session connection of the signals transmitted through the first sub-session of the physical layer session 1 and the physical layer session 2 and the signals transmitted through the second sub-session of the physical layer session 1 are subjected to a multiplexing division session connection.

In this way, data transmitted through a session of a transport layer and a session of a network layer, in addition to the session of the physical layer, are combined by session connection.

Also, for session connection according to a layer, each session includes a session identifier (ID), a sequence number, and an initial sequence number. The session ID, the sequence number, and the sequence number will now be described in detail.

First, the session ID will now be described in detail.

The session ID, when at least one layer generates at least two sessions, indicates an upper session or service that constitutes the at least two sessions, and is needed to recognize that any of the at least two sessions is used for the identical upper session or service in performing session connection by a combiner.

Secondly, the sequence number will now be described in detail.

The sequence number is a sequence number of data streams received using sessions of layers, and is needed to combine data streams received by using at least two sessions into one upper session or service for an identical upper session or service in a combiner.

If identical data streams are received by using at least two sessions, the UE performs a diversity combination session connection by electing one among from identical data streams having the same sequence number, or if different data streams are received by using at least two sessions, the UE performs a multiplexing combination session connection by aligning sequence numbers.

Thirdly, the initial sequence number will now be described in detail.

The initial sequence number indicates a starting sequence number of data streams received by using sessions of layers. The combiner recognizes the initial sequence number and performs session connection using a sequence number of data streams.

Hereinafter, with reference to FIG. 7, a session connection process performed by UE in a communication system according to an embodiment of the present invention will be described in detail.

FIG. 7 is a schematic diagram illustrating a session connection process performed by UE in a communication system according to an embodiment of the present invention.

Referring to FIG. 7, the term “TRP session” refers to a transport layer session which performs a diversity division session connection, the term “NET session” refers to a network layer session, and the term “PHY session” refers to a physical layer session. Referring to FIG. 7, when UE receives signals, one physical layer session may be constituted of one network layer session, for example, a physical layer session 3 is constituted of a network layer session 2. Also, two or more physical layer sessions are combined into one network layer session in a combiner of a MAC layer, and in FIG. 7, a physical layer session 1 and a physical layer session 2 are constituted of a network layer session 1.

Also, one physical layer session may be constituted of at least two network layer sessions, and in FIG. 7, the physical layer session 4 is constituted of a network layer session 3 and a network layer session 4.

Likewise, one network layer session may be constituted of one transport layer session, two or more network layer sessions are combined into one transport layer session in a combiner of a transport layer, and one network layer session may be constituted of at least two transport layer sessions.

Also, one transport layer session may be constituted of one session layer session, and two or more transport layer sessions may be combined into one session layer in a combiner of a session layer.

Also, when UE transmits signals, one network layer session may be constituted of one physical layer session. In FIG. 7, a network layer session 2 is constituted of a physical layer session 3. Also, one network layer session may be divided into two physical layer sessions in a combiner of a MAC layer. In FIG. 7, a network layer session 1 is divided into a physical layer session 1 and a physical layer session 2.

Also, at least two network layer sessions may be constituted of one physical layer session. In FIG. 7, a network layer session 3 and a network layer session 4 are constituted of a physical layer session 4. Likewise, one transport layer session may be constituted of one network layer session, one transport layer session may be divided into two or more network layer sessions in a combiner of a transport layer, and at least two transport layer sessions may be constituted of one network layer session. Also, one session layer session may be constituted of one transport layer session, and one session layer session may be divided into two or more transport layer sessions in a combiner of a session layer.

Also, when UE receives signals, at least one session characteristics may be combined when at least two sessions of at least one layer are combined. In FIG. 7, when the physical layer session 1 and the physical layer session 2 are combined by diversity connection, 0.02 bit error rate characteristics of the physical layer session 1 is combined with 0.03 bit error rate characteristics of the physical layer session 2 to form a session having one 0.01 bit error rate characteristics.

Also, in FIG. 7, when the network layer session 1 and the network layer session 2 are combined by multiplexing connection, 1 Vs use price characteristics of the network layer session 1 is combined with 0 Vs use price characteristics of the network layer session 2 to form a session having one 1 Vs use price characteristics. Also, when the transport layer session 1 and the transport layer session 2 are combined by multiplexing connection, 10 segments/s segment throughput characteristics of the transport layer session 1 is combined with 20 segments/s segment throughput characteristics of the transport layer session 2 to form a session having one 30 segments/s segment throughput characteristics.

As described above, when UE receives signals, during a session connection process, session characteristics of at least two sessions are combined and a session having one session characteristics is formed. Also, in this case, two or more session characteristics may also be combined.

Also, when UE transmits signals, when at least two sessions are combined, at least one session characteristics may be divided. In FIG. 7, when a session layer session is divided by multiplexing, a session layer session having 30 segments/s segment throughput characteristics may be divided into a transport layer session 1 having 10 segments/s segment throughput characteristics and a transport layer session 2 having 20 segments/s segment throughput characteristics.

Also, when the transport layer session 1 is divided by multiplexing, the transport layer session 1 having 1 Vs use price characteristics is divided into the network layer session 1 having 1 Vs use price characteristics and the network layer session 2 having 0 Vs use price characteristics.

Also, when the network layer session 1 is divided by diversity, the network layer session 1 having 0.01 bit error rate characteristics is divided into the physical layer session 1 having 0.02 bit error rate characteristics and the physical layer session 2 having 0.03 bit error rate characteristics.

As described above, when signals are transmitted, during a session connection process, a session characteristic of one session may be divided and the session may be divided into at least two sessions having the divided session characteristics. At least two or more session characteristics may also be divided.

Also, when the physical layer session 1 and physical layer session 2 are combined by diversity, a session having 0.01 bit error rate characteristics is generated by combining 0.02 bit error rate characteristics of the physical layer session 1 and 0.03 bit error rate characteristics of the physical layer session 2.

Also, when at least two physical layer transmission paths are used in the same communication network, at least two physical layer sessions may be combined in a physical layer, or at least two physical layer sessions may be combined in a MAC layer.

In this regard, regarding the session connection, a session connection controller may perform session connection of at least two sessions established in the same communication network, or may perform session connection of at least two sessions established through transmission paths of different communication networks. For example, a session connection controller may combine a network layer session established through LTE and a network layer session established through WLAN into one transport layer session in a combiner of a transport layer.

It should be understood that the exemplary embodiments described therein should be considered in a descriptive sense only and not for purposes of limitation. Descriptions of features or aspects within each embodiment should typically be considered as available for other similar features or aspects in other embodiments.

### INDUSTRIAL APPLICABILITY

this invention can be used in the field of network communication system.

What is claimed is:

1. A user equipment (UE) in a communication system, the UE comprising a session connection controller for controlling session connection of at least two sessions of a layer or each of at least two layers selected from the group consisting of a transport layer, a network layer, and a physical layer.

2. The UE of claim 1, wherein the session connection comprises any one of:
(a) sessions of at least two transport layers are combined into a session of at least one session layer; sessions of at least two network layers are combined into a session of at least one transport layer;
(b) sessions of at least two physical layers are combined into a session of at least one medium access control (MAC) layer or a session of at least one physical layer;
(c) a session of at least one session layer is divided into sessions of at least two transport layers;
(d) a session of at least one transport layer is divided into sessions of at least two network layers; and
(e) a session of at least one MAC layer or a session of at least one physical layer is divided into sessions of at least two physical layers.

3. The UE of claim 1, wherein the session connection comprises any one of:
(i) diversity combination is performed in which identical information is received through at least two sessions of a layer or each of at least two layers selected from the group consisting of a transport layer, a network layer, and a physical layer and combined, or identical information is divided and transmitted to at least two sessions,
(ii) multiplexing combination is performed in which different information are received through at least two sessions and combined, or different information is divided and transmitted to at least two sessions, or identical information and different information are simultaneously received through at least two sessions, and the identical information is subjected to diversity connection and the different information is subjected to multiplexing connection, and
(iii) identical information and different information are each divided for at least two sessions, and the identical information is subjected to diversity transmission and the different information is subjected to multiplexing transmission.

4. The UE of claim 3, wherein at least two sessions are established through different communication network.

5. The UE of claim 3, wherein the at least two sessions are established through different communication devices.

6. The UE of claim 1, further comprising a session characteristics determination unit for determining characteristics of a session of the layer or each of at least two layers selected from the group consisting of a transport layer, a network layer, and a physical layer.

7. The UE of claim 6, wherein the session characteristics determination unit determines at least one selected from the group consisting of a session size, a session connection mode, session flexibility, and quality of experience (QoE) of the layer or each of at least two layers selected from the group consisting of a transport layer, a network layer, and a physical layer.

8. The UE of claim 7, wherein the QoE comprises quality of service (QoS), and user experience quality,
wherein the session connection mode comprises multiplexing, diversity, and hybrid including multiplexing and diversity,
wherein the session flexibility comprises service and traffic, network load, and flexibility corresponding to a channel state,
wherein the QoS comprises a data rate, transfer delay, and packet loss, and
wherein the user experience quality comprises a mean opinion score (MOS), an un-response rate to call, R-Value, initial buffering time, and download time.

9. The UE of claim 6, wherein the session characteristics determination unit determines characteristics of a session of the layer or each of at least two layers selected from the group consisting of a transport layer, a network layer, and a physical layer by combining one or at least two selected from the group consisting of service characteristics information, communication quality information, network information, and channel characteristics information.

10. The UE of claim 9, wherein the service characteristics information comprises at least one selected from the group consisting of user preference, quality of experience (QoE) requirement parameter according to a session, and service price,
wherein the communication quality information comprises at least one selected from the group consisting of application layer information, session layer information, transport layer information, network layer information, medium access control (MAC) information, and physical layer information,
wherein the application layer information comprises availability, reconstruction quality, time constraint, service price, a data rate, jitter, transfer delay, and a peak signal-to-noise ratio (PSNR),
wherein the session layer information comprises a session state, the transport layer information comprises an end-to-end retransmission rate, end-to-end transfer delay, end packet loss, end-to-end throughput, and packet delay change,
wherein the network layer information comprises quality of service (QoS) information and routing information,
wherein the MAC layer information comprises a link retransmission rate, and a frame error rate, the physical layer information comprises a bit error rate, and signal strength,
wherein the network information is information that is supplied by networks with which the UE is to have a connection, and comprises a neighbor list (NL) information, a network load rate, and a price policy, and
wherein the channel characteristics information is transmission information for network connection of the UE, and comprises modulation method information, coding method information, transmit and receive method information, and multiple antenna method information.

11. The UE of claim 6, wherein the session characteristics determination unit determines a session size of the layer or each of at least two layers selected from the group consisting of a transport layer, a network layer, and a physical layer, wherein the session size is a size of the transmission path for exchanging data stream, packet, or signal in each layer to supply a user requirement service.

12. The UE of claim 11, wherein the session size of the transport layer is a segment throughput, the session size of the network layer is a packet throughput, and the session size of the physical layer is a channel capacity.

13. The UE of claim 6, wherein the session characteristics determination unit determines session flexibility of the layer or each of at least two layers selected from the group consisting of a transport layer, a network layer, and a physical layer, wherein the session flexibility is a degree of response to change of service and traffic, network load, and a channel state.

14. The UE of claim 6, wherein the session characteristics determination unit determines a quality of service (QoS) parameter of the layer or each of at least two layers selected from the group consisting of a transport layer, a network layer, and a physical layer,
wherein the QoS parameter of the transport layer comprises segment transfer delay, retransmission count, segment throughput, round trip time (RTT), and segment loss,
wherein the QoS parameter of the network layer comprises jitter, packet transfer delay, packet loss, packet throughput, and use price, and
wherein the QoS parameter of the physical layer comprises a received signal strength indicator (RSSI), signal-to-noise ratio (SNR), a signal-to-interference plus noise ratio (SINR), a channel capacity, a data rate, an error rate, an outrage rate, and signal transfer delay.

15. The UE of claim 6, wherein the session characteristics determination unit determines a user experience quality parameter of the layer or each of at least two layers selected from the group consisting of a transport layer, a network layer, and a physical layer,
wherein the user experience quality parameter for an audio service comprises mean opinion score (MOS), an un-response rate to call, and R-value, the user experience quality parameter for a video streaming service comprises initial buffering time, jerkiness, and audio and video synchronization,
wherein the user experience quality parameter for a WEB browsing service comprises a page reaction time, and
wherein the user experience quality parameter for a file exchange service comprises a data rate, and download time.

16. The UE of claim 1, wherein the UE further comprises a path characteristics determination unit that elects a transmission path for session connection of the layer or each of at least two layers selected from the group consisting of a transport layer, a network layer, and a physical layer, and determines characteristics of the elected transmission path.

17. The UE of claim 16, wherein the path characteristics determination unit determines at least one selected from the group consisting of a transmission path, the number of paths, a session size according to a path, and transmission characteristics according to a path of the layer or each of at least two layers selected from the group consisting of a transport layer, a network layer, and a physical layer, wherein the transmission characteristics according to a path comprise throughput, delay, an error rate, and a loss rate according to a path.
